(19) United States
(12) Patent Application Publication
(10) Pub. No.: US 2008/0142425 A1
(43) Pub. Date: Jun. 19, 2008

(54) Filter systems

(75) Inventor: Robert Hansen, Oakdale, MN (US)

Correspondence Address: Carl L. Johnson;Jacobson and Johnson, Suite 285, One West Water Street, St. Paul, MN, 55107-2080, US

(73) Assignee: Dynamic Air Inc.

(21) Appl. No.: 11/642,014

(22) Filed: Dec. 19, 2006

(51) Int. Cl. B01D 35/30; B01D 29/96

(52) U.S. Cl. 210/232; 210/238

(57) ABSTRACT

A filter cartridge having a filter end cap with a set of circumferentially spaced multifaceted dogs that can laterally support a filter on a filter mount as well as latch the filter securely lock the filter end cap to the filter mount while preventing the problem of mounting incorrect filter cartridges as well as a method of mounting

### FIELD OF THE INVENTION

This invention relates generally to filter systems having filter mounts and filter cartridges and, more specifically, to multifaceted dogs for forming face to face engagement in fluid filtering systems.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The concept of industrial filter mounts and industrial filters with a metal end cap are known in the art of conveying systems. Typically, the industrial filters can have a diameter of a foot or more and a length of several feet. The filter mount, which attaches to the conveying system, includes a set of dogs that engage a set of beveled dogs, which are stamped in the metal end cap of the filter cartridge, to hold the industrial filter on the filter mount. Typically, the filter mount includes a set of four dogs that rotationally wedge against a set of four beveled dogs, which have been stamped in the metal end cap. Forming a filter end cap with stamped beveled dogs is relatively inexpensive and the beveled edges on the beveled dogs act to wedge the filter mount to the filter. While it is desirable to securely wedge or lock the filter to the filter mount it has been found that because of the indefinite positional relationship of the engagement surface on the angled dog with the dogs on the filter mount it can lead to placement of improper filters on the filter mount. The present invention provides an improved filter end cap with a set of multifaceted dogs and a method of mounting a filter end cap to a housing to ensure that the proper filter is mounted on the filter mount as well as having the filter and filter mount properly latched together.

### SUMMARY OF THE INVENTION

Briefly, the present invention comprises a filter cartridge having a filter end cap with a set of circumferentially spaced multifaceted dogs that can laterally support a filter on a filter mount as well as latch the filter securely lock the filter end cap to the filter mount while preventing the problem of mounting incorrect filter cartridges and a method of securing a filter cartridge to a filter mount.

### BRIEF DESCRIPTION OF THE DRAWINGS

FIG. 1 is an exploded view of a filter mount and a molded filter ring in an unlatched condition;

FIG. 2 shows in partial section the filter mount and the molded filter ring of a filter in an assembled condition;

FIG. 3 is a top perspective view of the filter of FIG. 1;

FIG. 4 is a bottom view of the filter mount and the molded filter ring of FIG. 1 in an assembled but unlatched condition;

FIG. 5 is the bottom view of the filter mount and the molded filter ring of FIG. 4 in the latched condition;

FIG. 6 is an isolated front view of a prior art beveled dog;

FIG. 6A is a cross sectional view of the beveled dog taken along lines 6A-6A of FIG. 6;

FIG. 7 is an isolated front view of the multifaceted dog of the present invention;

FIG. 7A is a cross sectional view of the multifaceted dog of FIG. 7 dog taken along lines 7A-7A of FIG. 7;

FIG. 7B shows an isolated view of a mount stop;

FIG. 8 is a partial section view of a pair of multifaceted dogs on a filter cap positioned proximate the radial dogs on a filter mount illustrating an unlatched condition;

FIG. 9 is a partial section view of a pair of multifaceted dogs on a filter cap sliding over the radial dogs on a filter mount illustrating the mating engagement between the multifaceted dogs and the radial dogs;

FIG. 10 is a partial section view of a pair of multifaceted dogs on a filter cap engaging the radial dogs on a filter housing and a stop limiting the rotational displacement between the filter end cap and the filter mount; and

FIG. 10A is a cross sectional view taken along lines 10A-10A of FIG. 10.

### DESCRIPTION OF THE PREFERRED EMBODIMENT

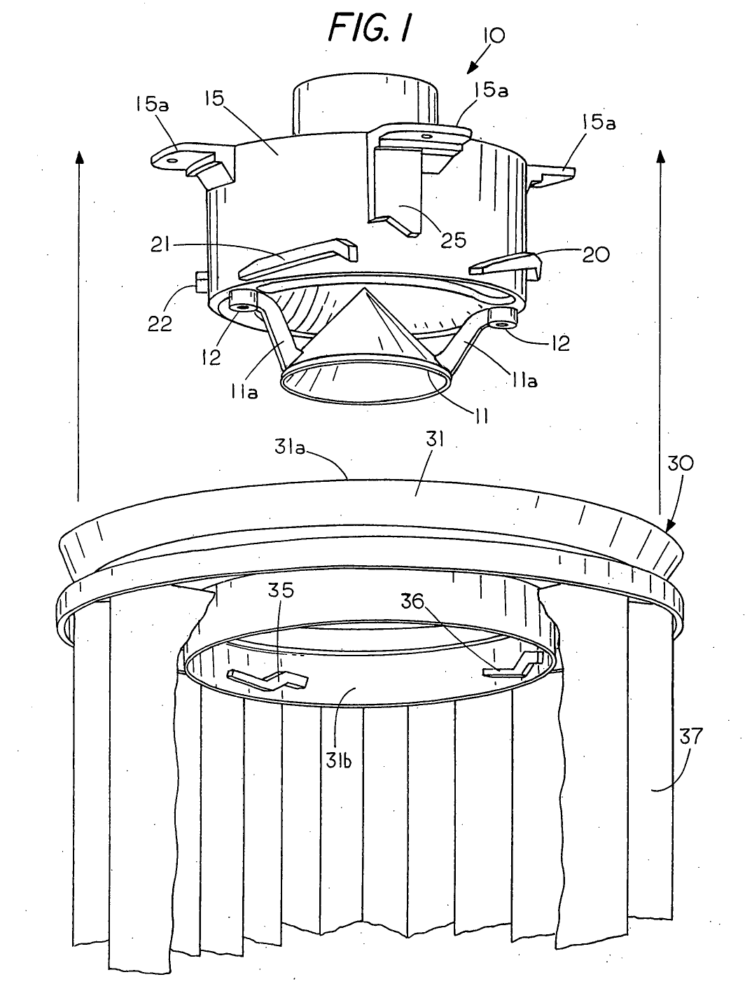

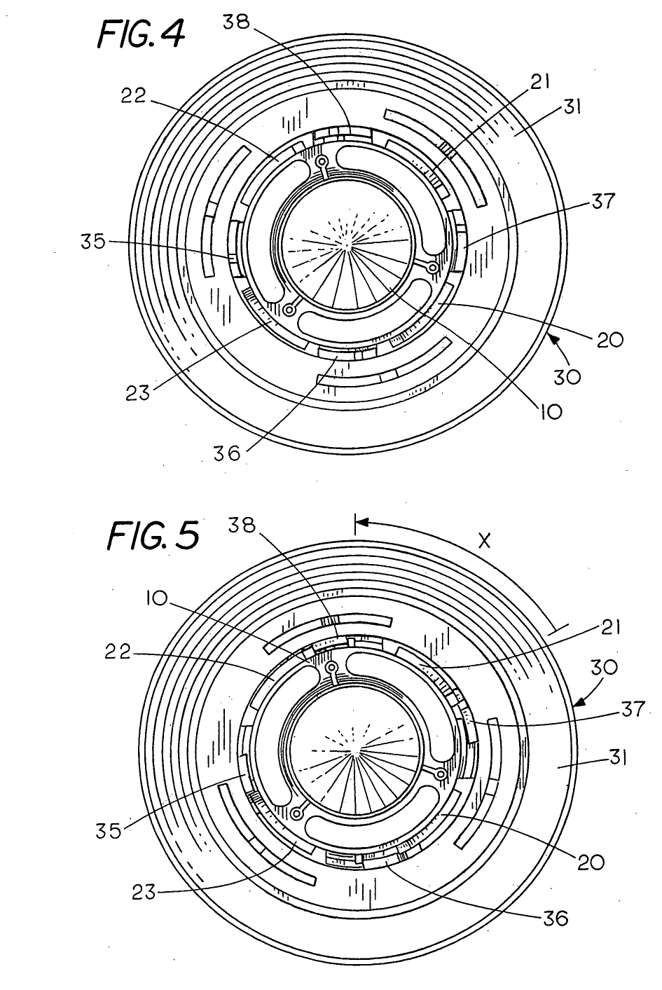

FIG. 1 is an exploded view of a filter mount 10 and a filter 30 having a filter end cap 31. The filter mount 10 is fixedly connected to a conveying system filter housing (not shown) through flanges 15a that extend radially outward from the top of filter mount 10. A conical shaped fluid deflector 11 is secured to the underside of filter mount 10 by a set of bolts 12 that extend through openings in the ends of three radial arms 11a. The fluid deflector is used when flow is reversed in order to clean the filter media. The filter mount 10 includes a set of four elevating dogs that engage a set of multifaceted dogs on the filter end cap to hold the filter 30 in position. More specifically, filter mount 10 includes a set of four identical circumferential spaced elevating dogs 20, 21, 22 and a fourth elevating dog 23 (shown in top view in FIG. 4 and FIG. 5). While four elevating dogs are used more or less elevating dogs could be used. In the embodiment shown the elevating dogs are equally spaced around the circumferential band 15, Also located on filter mount 10 is a mount stop 25 for limiting axial displacement of a filter secured thereto as well as limiting rotation of a filter about the filter mount. In the embodiment shown two mount stops are formed on band 15 and are located diametrical opposite from each other. While two mount stops can be used it is understood that one mount stop could be used.

Located below the filter mount 10 is the industrial filter cartridge 30 (shown partially in section) having a cylindrical filter end cap 31 that covers the ends of the pleated filter media 37. The filter end cap 31 comprises a top member 31a and an inner band 31b that carries a set of filter cap dogs. Located on the bottom of pleated filter media 37 is another end cap (not shown) to hold the other end of the pleated filter media in position during the filtering process. In the embodiment shown there is a set of four identical circumferential spaced filter cap multifaceted dogs 35, 36 (shown in FIG. 1) 37, and 38 (shown in FIG. 4 and FIG. 5) that engage with the set of elevating dogs 20, 21 22 (shown in FIG. 1) and elevating dog 23 (shown in FIG. 4 and FIG. 5) to hold the filter 30 on the filter mount 10.

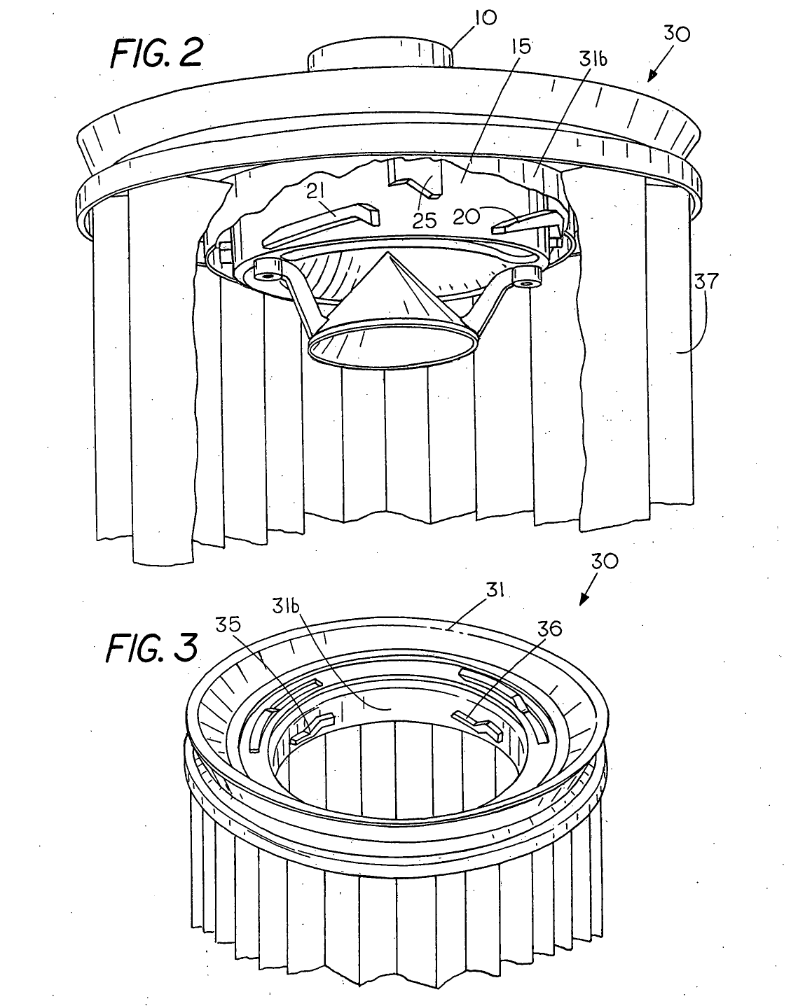

FIG. 2 shows a partial cutaway view of the filter 30 proximate to the filter mount 10 with a portion of the filter and the filter band 31b removed to reveal the mounted position of the filter 30 with respect to the filter mount 10.

FIG. 3 shows a top perspective view of the filter cartridge 30 comprised of a filter end cap molded from a polymer plastic and attached thereto a filter band 31b also molded from a polymer plastic with the filter band 31b supporting the multifaceted dogs 35 and 36 that extend radially inward from the filter band 31b of the filter cartridge 30. Although not shown in FIG. 3, each of the multifaceted dogs 35, 36, 37, and 38 extend radially inward from the filter band 31b sufficiently far to provide surface engagement with the corresponding elevating dogs on the filter mount band 15 but not so far so as to engage the filter band 15 when the filter 30 and the filter mount 10 are in a concentric condition. Similarly, the elevating dogs 20, 21, 22, and 23 extend sufficiently outward radially to surface engage the multifaceted dogs 35, 36, 37 and 38 but not so far so as to engage the filter band 31b when the filter 30 and the filter mount 10 are in a concentric condition with each other. In addition the circumferential length of the multifaceted dogs and the circumferential length of the elevating dogs is such that when the filter mount 10 and the filter 30 are in a concentric but unlatched condition the elevating dogs and the multifaceted dogs can extend axially between each other without engaging each other. This feature is illustrated in FIG. 4.

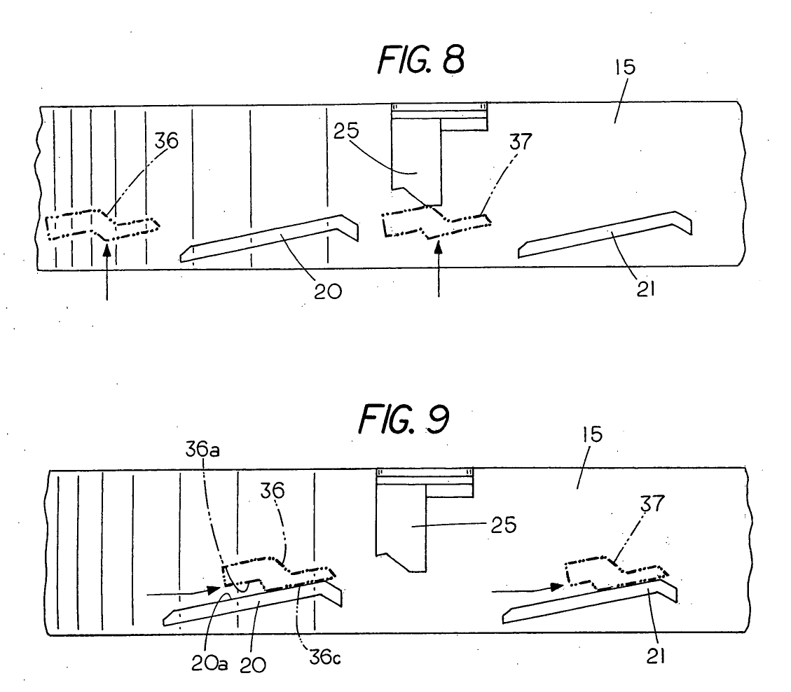

FIG. 4 shows a top view of the filter mount 10 showing the four circumferentially spaced elevating dogs 20, 21, 22 and 23 on the filter mount 10 positioned proximate each of the four circumferentially spaced multifaceted dogs 35, 36, 37 & 38 on the filter cartridge 30. As shown in FIG. 4 the filter end cap 31 and the filter mount 10 are in the initial stage of securement of the filter 30 to the filter mount 10. That is, the filter end cap 31 has been axially and concentrically inserted onto the filter mount 10 with the elevating dogs of the filter mount and the multifaceted dogs of the filter band 31b aligned so that the dogs can extend axially past one another when the filter mount 10 and the filter cartridge are in a concentric relationship. FIG. 8 shows a partial sectional view of the band 15 having elevating dog 20 and 21 located adjacent the multifaceted dogs 36 and 37, which are shown without the filter end cap in order to illustrate the first stage of assembly of the filter end cap to the filter mount 10 where the each of the multifaceted dogs on the filter 30 can extend past an elevating dog of the filter mount 10.

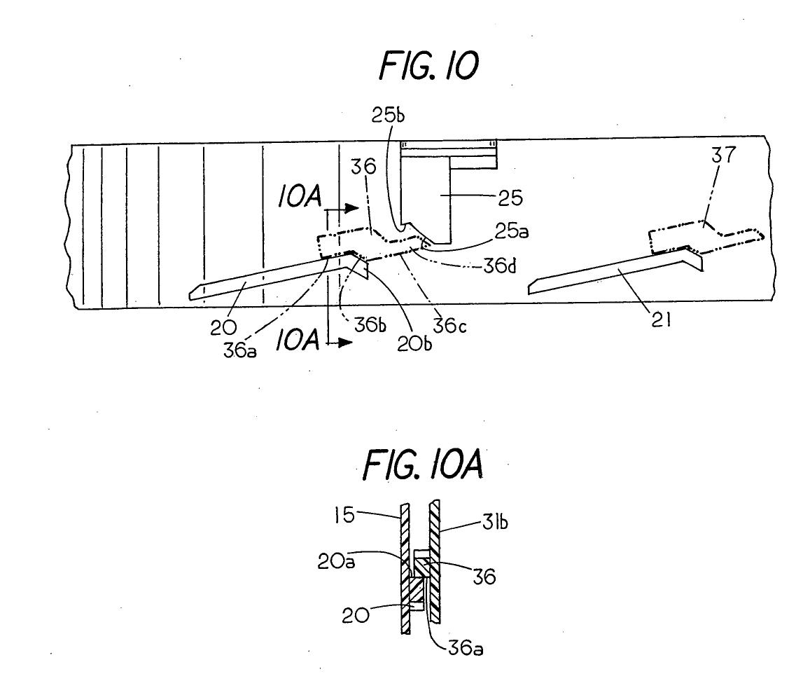

FIG. 5 illustrates a second step in the assembly process wherein the filter 30 has been rotated a distance denoted by x with respect to the filter mount 10. As a result of the rotation each of the filter cap multifaceted dogs are in contact with an adjacent elevation dog on the filter mount 10. This condition is illustrated in FIG. 9 which shows the filter mount elevating dog 20 and the filter end cap multifaceted dog 36 in engagement therewith as well as filter mount multifaceted dog 37 in engagement with elevating dog 21. FIG. 10 illustrates a latched condition wherein the filter mount elevating dogs 20 and 21 are in latched engagement with the multifaceted dogs 36 and 37 on the filter end cap.

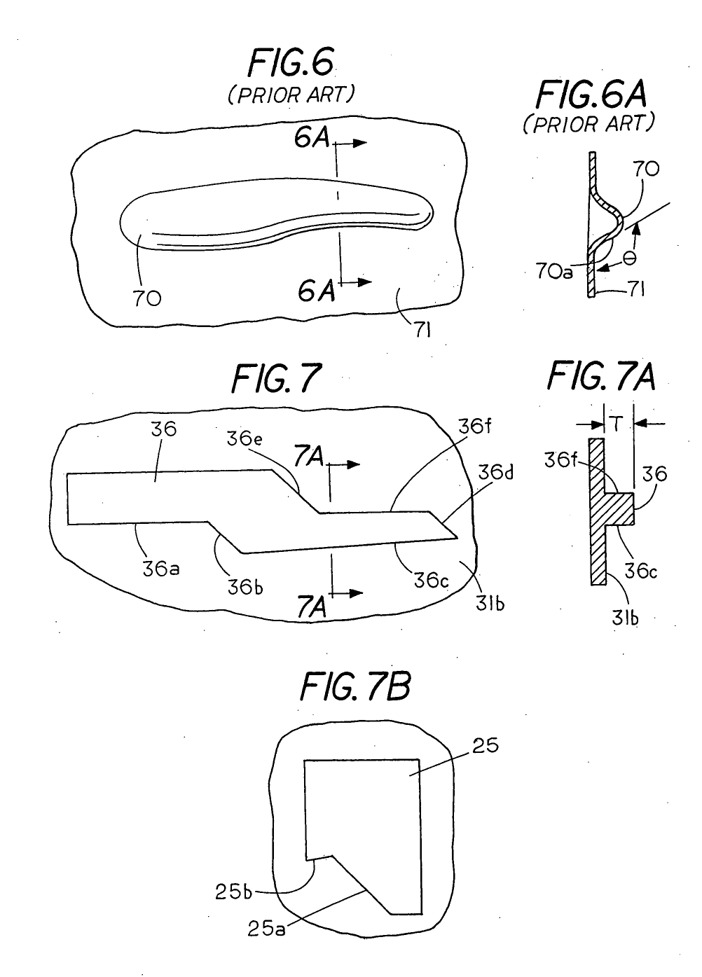

To appreciate the latching dogs of the present invention as opposed to the dogs of the prior art reference should be made to FIG. 6 and FIG. 6A. FIG. 6 shows a top view of a prior art beveled dog 70 that has been stamped in a filter band 71 and FIG. 6A shows a cross section view of the beveled dog 70 revealing that the under surface 70a of the beveled dog 70 extents at an obtuse angle E with respect to band 71. The beveled wall is useful in that it allows for large tolerances between the filter mount and the filter housing since engagement between the edge of the dogs on the filter mount and the beveled surface of the beveled dogs can occur at various locations along the beveled dog thereby making it useful for applications on large industrial filters where the dimensions of the filter and the filter mount can vary as well as making it less expensive to manufacture. However, the beveled dogs of the prior art can lead to problems in mating the filter mount to the filter cartridge sometimes leading to mounting the incorrect filter on the filter mount. The use of a multifaceted dog 36, such as shown in FIG. 7 and 7A, eliminates problems wherein the incorrect filter is mounted on the filter mount. FIG. 7 shows an isolated front view of the multifaceted dog 36 of the present invention and a cutaway portion of filter band 31b that carries the multifaceted dog 36.

FIG. 7A shows a section view taken along lines 7A-7A of FIG. 7 showing that dog 36 extends a distance “T” outward form the band. An under facet of dog 36 comprises a laterally extending runner or glide surface 36c that is located at a right angle or substantially at a right angle with respect to the band 31b that can form face to face engagement with a face 20a of an elevating dog 20. FIG. 7 shows a further angled facet 36d located at one end of dog 36 to form a filter front stop 36d i.e. a filter mount engaging stop. Correspondingly, facet 36b forms a filter backstop and facet 36a forms a support ledge to support the filter end cap 31 on the elevating dog of the filter mount. Thus the multifaceted dog 36 includes a support facet 36a axially offset from the facet 36c comprising a runner.

Each of the faces 36a, 36b and 36e comprise faces that lie in only one plane and extend at a right angle or substantially at a right angle with respect to the band 31b. Thus, it can be seen the multifaceted stop 36 provides a set of distinct faces that can laterally slid alone each other to engage in surface to surface contact with the dogs on the filter mount 10 as opposed to the prior art beveled dog 70 wherein the beveled face thereon tends to make only edge contact with the dogs on the filter mount. Face 36c and face 36a are substantially parallel to each other while face 36b extends in a plane that intersects both the plane of face 36c and the plane of face 36a.

FIG. 7B is an isolated front view of a mount stop 25 (shown in FIG. 1 for use with the multifaceted dogs 36. Stop 25 extends radially outward from the filter mount band 10 and includes a first angled facet 25a comprising a rotational stop and a second angled facet 25b forming an axial stop to hold a filter cartridge in a latched condition on filter mount 10.

To illustrate the axial and rotational engagement as well as the latching between cartridge 30 and filter mount 10 references should be made to FIGS. 8-10.

FIG. 8 shows a partial section view of the filter mount band 15 having elevating dog 20 and 21 extending therefrom. The multifaceted dog 36 and the multifaceted dog 37 are shown in isolated view without the filter 30 or the filter band 31b in order to illustrate the coaction of the multifaceted dog 36 with the elevating dog 20 and the multifaceted dog 37 with the elevating dog 21. The position of the multifaceted dogs relative to the elevating dogs illustrates the first stage of assembly of the filter end cap 31 to the filter mount 10 wherein the filter end cap 31 is concentrically aligned with the filter mount 10. In the first stage of assemble the multifaceted dog 36 (which is on the filter cartridge 30) is positioned proximate an elevating dog 20 on the filter mount band 15 by axially inserting the filter 30 with filter end cap 31 onto the filter mount 10. That is, multifaceted dog 36 is in a condition to be rotated into engagement with an adjacent elevating dog 20 and multifaceted dog 37 is also in a condition to be rotated into engagement with an adjacent elevating dog 21. To illustrate the coaction of the multifaceted dogs and the elevating dogs the interaction of dog 36 and dog 20 will be described but it is understood that the identical action occurs with each of the other multifaceted dog and their corresponding elevating dog.

FIG. 9 illustrates the rotational stage where the filter cartridge 30 (carrying multifaceted dogs 36 and 37) is rotated onto the filter mount 10. As rotation proceeds the runner 36c on multifaceted dog 36 slides up the top face 20a of elevating dog 36 thus bringing the filter end cap 31 and the filter mount 10 into axial position. That is, the rotational displacement of filter 31 with respect to filter mount 10 causes the runner 36c to slide up the top ramp face 20a of elevating dog 20. Because the runner 36c mates on top of the top ramp face 20a the runner 36c and top ramp surface 20a smoothly engage each other to axially displace the filter end cap toward the filter mount 10 as rotation is continued.

FIG. 10 illustrates the final stage in the rotation of the filter 30 with respect to the filter mount 10. In this condition three faces of the multifaceted dog 36 have been brought into engagement with the mount 10. That is, the face 36c of dog 36 has slid off the top ramp face 20a and the glide or runner face 36c is no longer in contact with the ramp dog 20; however, the support face 36a of dog 36 is now in engagement with top ramp face 20a to axially support the filter end cap 31 on the filter mount 10. In addition, the backstop face 36b on multifaceted stop 36 is in engagement with ramp lip 20b on elevating dog 20 while angled facet 36d forms a filter axial stop and a filter circumferential stop when multifaceted dog 36 is proximate the mount stop 25. The mount stop 25, which extends outward form band 15 is shown in isolated view in FIG. 7B and includes a face 25a that forms a rotational stop and a face 25b that forms an axial stop with one of the multifaceted dogs on the filter end cap 31.

FIG. 9 and FIG. 10 shows that each of the set of multifaceted dogs includes at least two facets 36a and 36c only one of which can form lateral face to face contact with a top surface 20a of an elevating dog 20 at the same time. In the embodiment shown the at least two facets 36a and 36c that can form lateral face to face contact with the top surface on a elevating dog 20 are substantially parallel to each other. As can be seen in FIG. 10 the multifaceted dog 36 has been latched between the lip 20b and the rotational stop 25a of mount 25 to thereby inhibit axial or rotational movement of filter 31 with respect to filter mount 10. Thus, through the use of face to face contact between dogs on a filter mount and on an end cap of a filter cartridge the face to edge contact that can occur with angled dogs has been eliminated and with it the coaction therewith that leads to placement of improper cartridges on the filter mount.

FIG. 10A shows a sectional view taken along lines 10A-10A of FIG. 10 to reveal how the elevating dog 20 and the multifaceted dog provide lateral surface to surface (face to face) contact as opposed to the prior art filter cartridge beveled dog that provides edge contact between the dogs on the filter mount and the beveled dogs. Note, the facet 36a engages the facet 20a in a surface to surface contact rather than the edge contact found with beveled dogs. Thus through change of the shape of the dog on the filter cartridge one can avoid the problem of placement of the improper filter cartridge on the filter mount.

The invention also includes a method of mounting a filter cartridge to a filter mount comprising the steps of concentrically aligning a central axis of filter cartridge 30 with a central axis of a filter mount 10, placing a top surface of an elevating dog in face to face contact with at least one face of a multifaceted dog; and rotating the filter cartridge with respect to the filter mount to axially displace the filter cartridge with respect to the filter mount while the top surface of the elevating dog are in face to face contact with at least one face of the multifaceted dog.

The method further includes the step of continuing to rotate the filter cartridge 30 with respect to the filter mount 10 to bring the top surface of the elevating dog in face to face contact with a further face on the multifaceted dog while disengaging the at least one face of the multifaceted dog from the top surface of the multifaceted dog.

The method further includes the step of bringing an end facet of the multifaceted dog into engaging with a mount 25 stop to prevent further rotation of the filter cartridge with respect to the filter mount.

The method further includes the step of bringing each of a set of at least four multifaceted doges into engagement with a corresponding elevating dog.

The method further includes the step of rotating the filter cartridge until a back stop 36b on a multifaceted dog is brought into engagement with a lip 20b on the elevating dog to inhibit removal of the filter cartridge from the filter mount.

While the elevating dogs are shown on the filter mount and the multifaceted dogs are shown on the band of the cartridge it is envisioned that the elevating dogs could be mounted on the filter cartridge and the multifaceted dogs could be formed on the filter mount.

1. An industrial filter comprising:
a filter media;
a filter end cap located on an end of the cylindrical filter media, said filter end cap having a band with a set of circumferential spaced multifaceted dogs extending radially inward therefrom with the set of multifaceted dog each having at least one facet extending at a right angle or a substantially right angle to the band.

2. The industrial filter of claim 1 wherein an end of at least one of the multifaceted dogs includes a facet forming a filter mount engaging stop.

3. The industrial filter of claim 1 wherein the filter end cap comprises a molded polymer plastic filter end cap.

4. The industrial filter of claim 1 wherein the set of circumferential spaced multifaceted dogs comprises four circumferentially spaced multifaceted dogs.

5. The industrial filter of claim 4 wherein each of the circumferential spaced multifaceted dogs includes one facet comprising a runner for a face to face engagement with a face of an elevating dog on a filter mount.

6. The industrial filter of claim 5 where each of the circumferential spaced multifaceted dogs have a support facet axially offset from the facet comprising a runner.

7. The industrial filter of claim 6 wherein at least one of the multifaceted dogs includes an angled end facet for forming an axial and circumferential stop.

8. The industrial filter of claim 7 wherein each of the set of multifaceted dogs includes at least two facets only one of which can form lateral face to face contact with a top surface of an elevating dog at the same time.

9. The industrial filter of claim 8 wherein the at least two facets that can form lateral face to face contact with the top surface on the elevating dog are substantially parallel to each other.

10. The industrial filter of claim 9 wherein at least one of the set of multifaceted dogs includes a facet forming an elevating dog back stop.

11. The industrial filter of claim 10 wherein each of the multifaceted dogs is integrally molded into the band secured to the filter end cap.

12. A filtering system comprising:
a filter mount having a set of elevating dogs having a top surface located at an acute angle with respect to a central axis of the filter mount;
a filter cartridge having a band having a set of multifaceted dogs each having a first facet for lateral face to face sliding along the top surface to axially displace the filter cartridge as the filter cartridge is rotated with respect to the filter mount.

13. The filtering system of claim 12 including a second facet on each of said set of multifaceted dogs with said second face axially and circumferentially offset from said first facet to provide face to face axial support of the filter cartridge when said first facet is not in face to face contact with said top surface.

14. The filtering system of claim 13 wherein the band of the filter cartridge comprises a molded polymer plastic and the set of multifaceted dogs are integral therewith.

15. The filtering system of claim 14 wherein the filter mount includes a mount stop and at least one of the set of multifaceted dogs includes an end facet for engaging the mount stop to prevent axial and rotational displacement of the filter cartridge.

16. The method of mounting a filter cartridge to a filter mount comprising the steps of concentrically aligning an axis of filter cartridge with an axis of a filter mount;
placing a top surface of an elevating dog in face to face to contact with at least one face of a multifaceted dog; and
rotating the filter cartridge with respect to the filter mount to axially displace the filter cartridge with respect to the filter mount while the top surface of the elevating dog are in face to face contact with at least one face of the multifaceted dog.

17. The method of claim 16 including the step of continuing to rotate the filter cartridge with respect to the filter mount to bring the top surface of the elevating dog in face to face contact with a further face on the multifaceted dog while disengaging the at least one face of the multifaceted dog from the top surface of the multifaceted dog.

18. The method of claim 17 including the step of bringing an end facet of the multifaceted dog into engaging with a mount stop to prevent further rotation of the filter cartridge with respect to the filter mount.

19. The method of claim 18 including the step of bringing each of a set of at least four multifaceted doges into engagement with a corresponding elevating dog.

20. The method of claim 19 wherein the filter cartridge is rotated until a back stop on a multifaceted dog is brought into engagement with a lip on the elevating dog to inhibit removal of the filter cartridge from the filter mount.
